(19) United States
(12) Patent Application Publication
(10) Pub. No.: US 2018/0250845 A1
(43) Pub. Date: Sep. 6, 2018

(54) METHOD FOR MANUFACTURING PIECES BY THE TECHNIQUE OF ADDITIVE MANUFACTURING BY PASTY PROCESS WITH AN IMPROVED SUPPLY OF PASTE AND MANUFACTURING MACHINE FOR IMPLEMENTING THE METHOD

(71) Applicant: 3DCERAM, Limoges (FR)

(72) Inventors: Richard GAIGNON, Saint-Vrain (FR); Christophe CHAPUT, Le Palais sur Vienne (FR)

(21) Appl. No.: 15/897,880

(22) Filed: Feb. 15, 2018

(30) Foreign Application Priority Data
Mar. 1, 2017 (FR) 1751685

(51) Int. Cl. B28B 1/00; B28B 11/24

(52) U.S. Cl. CPC B28B 1/001; B28B 11/24

(57) ABSTRACT

Disclosed is a method for manufacturing a piece, especially a green piece made of ceramic material, by the technique of additive manufacturing according to which layers of a photocurable paste are successively allowed to cure according to a pattern defined for each layer, the first layer being formed on a working surface on a working tray, each layer, before curing according to a defined pattern, being spread by scraping by one scraping blade or parallel scraping blades from an amount of paste supplied onto the working tray, which is lowered upon each formation of a layer. Upon each formation of a layer, the amount of paste necessary to form the layer is dispensed onto the working surface, from at least one nozzle which is moved in front of the scraping blade, or in the case of parallel scraping blades, in front of the front scraping blade.

The present invention relates to a method for manufacturing pieces by additive manufacturing also called stereolithography and to a manufacturing machine for implementing the method.

These parts are especially green pieces made of ceramic material, which are intended to be subjected to cleaning, debinding and sintering operations so as to obtain finished ceramic pieces.

### BACKGROUND OF THE INVENTION

The technique of additive manufacturing for obtaining such green pieces generally comprises the following steps:
building, by computer-aided design, a computer model of the piece to be manufactured, the sizes of such a model being larger than those of the piece to be manufactured so as to anticipate shrinking of the ceramic during the sintering of the piece;
forming, on a rigid working tray, a first layer of a photocurable composition comprising, for example, at least one ceramic material, at least one photocurable monomer and/or oligomer, at least one photoinitiator and usually at least one plasticizer and/or at least one dispersant;
curing said first layer by irradiation according to a pattern defined from the model for said layer, forming a first stage;
forming, on said first stage, a second layer of the photocurable composition;
curing said second layer by irradiation according to a pattern defined for said layer, forming a second stage;
repeating the steps of forming a layer followed by curing the layer until the green piece is obtained.

The irradiation of the layers is performed by a laser scanning of the free surface of the spread photocurable composition or by a diode (LED) projection system or by any other light sources especially of the UV-type.

The present invention relates to additive manufacturing methods in which the photocurable composition takes the form of a paste the composition of which is photocurable, such as the one indicated above, and the viscosity of which may vary especially from 1 Pa·s to infinity for a zero shear rate.

In a manufacturing by pasty process, the working tray supports the different layers of the piece being manufactured as well as the amount of paste to be spread each time a layer is formed. Each of the layers is formed by lowering the working tray and spreading a large bead of paste for obtaining a layer with a predefined paste thickness which is formed on the working tray for the first layer or on the previous layer for the other layers of the stack. To that end, a supply of paste is stored in a tank which is automatically emptied of the predefined amount of paste at each layer by means of a piston, the piston raising this amount of paste through a slot so as to form the bead in the vicinity of an edge of the working surface. The paste bead is then spread by scraping by means of a scraping blade which, urged to be placed behind it, causes it to move forward while sweeping the working surface to its opposite edge so as to spread the bead with a pass motion perpendicular to the edge of the scraping blade.

Such a paste supply onto the working tray has several drawbacks:
important scraping efforts can be caused, during the building phase by layers, so that the pieces break or move during their manufacturing, generating defects;
the volume of the paste bead corresponds to the length of the working surface; in other words, the more the working surface is large, the more the necessary amount of paste is large; this results in difficulties:
   over the width: the paste supply system is supposed to uniformly supply the paste over the entire width; such a homogenous supplying in width is difficult to develop in practice because the distribution depends on the width and on the amount of paste; if the amount of paste supplied is too small (the piston does not raise enough), the paste tends to come out in the middle and not much on the sides, which forces to require a minimal rise of paste so as to try to find a good homogeneity, with the risk of having extra paste in the middle of the working surface;
   over the length: the longer the working surface is, the more the scraping blade has to push paste to spread it; on the one hand, it increases the risk of formation of menisci, which menisci generate defects of the pieces, such as a lack of material, a tearing, etc., and, on the other hand, the more the bead being pushed is bulky, the more stresses on the already cured lower layers are generated;
   the manufactured pieces can only be made from a single ceramic material because there is only one paste supply.

To conclude, the current paste supply system does not always ensure the homogeneity of each spread layer, leads to important scraping efforts which may damage and even destroy the pieces being built, limits the working surface in both length and width, limits the height of the pieces to be built and only allows to print one ceramic at a time.

The Applicant Company has searched for a new paste supply system allowing to remove at least one of these drawbacks.

To that end, it is provided, according to the invention, that the paste is no more supplied from a paste bead brought along an edge of the working surface, but that the paste is supplied on the working surface from above the working surface, particularly from at least one nozzle arranged above the working surface and moveable to ensure an even supplying thereonto.

For example, by providing for a nozzle for dispensing a paste strand, which nozzle moves both back and forth on the width of the working surface (according to the axis Y) and straightly on the length of the working surface (according to the axis X) so that the paste strand is always located in front of the scraping blade in operation, an even serpentine of paste is formed on the working surface, which serpentine ensures an even and continuous spread of paste and does not require an important scraping effort because, each time, the scraping blade only pushes the useful amount of paste.

Thus, shear stresses related to a paste being spread onto a great length are minimized, even removed, and the formation of menisci is greatly reduced.

Furthermore, such a dispensing of the paste can be performed in the transversal direction on a width of the working tray much larger than that of the working trays which have been existing so far. The invention will therefore allow to make working trays much wider than currently (300 mm maximum) and theoretically with widths without limit.

Likewise, since the amount of paste for one layer is not fully supplied at the beginning but as and when the scraping blade moves forward by being supplied in front thereof whatever its progressing position, it is possible to well adjust the useful amount so as to avoid the formation of menisci and to minimize, even remove, stresses on the already cured lower layers; as a result, the scraping blade can work on a much greater length and more quickly due to little or no stress.

Besides, the fact that, each time a layer is formed, only the necessary amount of paste is supplied, allows the layers to be formed with materials which can be different from one layer to the other. It is therefore possible to form multi-material pieces, for example, ceramic pieces.

It is clearly provided, within the scope of the present invention, that several nozzles should be activated in a same pass, simultaneously or not, through programming of the nozzles, in the way of an inkjet printer, in order to have several materials on a same layer. It is therefore possible to deposit different materials at different widths on a same layer.

Furthermore, it is possible to provide layers of a photocurable composition without the ceramic material, in other words, of a composition comprising at least one photocurable monomer and/or oligomer, at least one photoinitiator and, if necessary, at least one additive, such as a plasticizer or a dispersant. Such layers can be supporting layers which will be destroyed when the piece is debinded or can be layers creating cavities necessary when the pieces are built, which layers will be destroyed during the debinding process.

Finally, it is possible to provide that the dispensing of paste in front of the blade should be programmable, that is to say activated and stopped on demand, which allows to provide the formation of several pieces in parallel on the width and/or the length of a working tray, the dispensing of paste by the nozzle(s) being activated only around the location of each piece to be formed on the working tray.

### BRIEF SUMMARY OF THE INVENTION

The subject-matter of the present invention is a method for manufacturing a piece, especially a green piece made of ceramic material, by the technique of additive manufacturing according to which layers of a photocurable paste are successively allowed to cure according to a pattern defined for each layer, the first layer being formed on a working surface on a working tray, each layer, before curing according to a defined pattern, being spread by scraping by one scraping blade or parallel scraping blades from an amount of paste supplied onto said working tray, which is lowered upon each formation of a layer, characterised in that, upon each formation of a layer, the amount of paste necessary to form said layer is dispensed onto the working surface, from at least one nozzle which is moved in front of the scraping blade, or in the case of parallel scraping blades, in front of the front scraping blade.

The nozzle or each nozzle can be moved transversally back and forth parallel to the scraping blade or to the scraping blades and longitudinally according to the advance movement of the one or more scraping blades from an edge of the working surface to the opposite edge thereof.

At least one parameter selected among the flow rate of the nozzle or of each nozzle and the transversal and longitudinal advance speeds of the nozzle or of each nozzle can be adjusted depending on at least one parameter selected especially among the viscosity of the paste and the thickness of the layer.

The dispensing of paste by one nozzle or each nozzle can be controlled depending on the layer to be formed.

The nozzle or each nozzle can be supplied with paste by means of a pipe for supplying paste from a paste tank or the nozzle or each nozzle can be supplied with paste by means of a paste cartridge which forms the upper part of the nozzle or of each nozzle and which contains a stock of paste advantageously sufficient to form at least one layer.

The paste can be dispensed from at least two nozzles aligned according to an axis parallel to the one or more scraping blades or according to an axis perpendicular to the one or more scraping blades.

When spreading at least one of the paste layers, at least one scraping blade in working position, in addition to its scraping advance movement, is allowed to go back and forth in its plane according to a so-called vibration motion.

The paste deposit can be controlled in a continuous way, thus forming a paste strand on the working surface, and/or in a discontinuous way, thus forming deposits by points on the working surface.

The invention relates also to a machine for manufacturing pieces, especially green pieces made of ceramic material, by the technique of additive manufacturing according to which layers of photocurable paste are successively allowed to cure by irradiation according a pattern defined for each layer, said machine comprising:
a frame surrounding a horizontal working tray comprising a working surface;
a portal frame equipped with at least one scraping blade, the portal frame being adapted to move on the frame over the working tray so that the free edge of the one or more scraping blades is adapted to spread, by scraping, paste layers over the working surface, said layers being vertically superimposed;
irradiation means facing the working tray to irradiate each layer once spread to cure it in the previously defined pattern before spreading the following layer, which is in turn cured in the defined pattern; and
supplying means of an amount of paste on the working tray upon each formation of a layer, said amount being intended to be spread by scraping by the one or more scraper blades so as to form the associated layer,
   characterised in that the supplying means of an amount of paste on the working tray are constituted by at least one dispensing nozzle moveable in front of the scraping blade or, in the case of parallel scraping blades, in front of the front scraping blade, the or each dispensing nozzle being adapted to apply paste according to a predefined program corresponding to the associated layer, so that the one or more scraping blades can spread the paste applied in a uniform layer when passing over it.

The or at least one of the nozzles of the machine can be supplied with paste by a flexible pipe connected to a paste tank, particularly a piston-type supply tank, or the or at least one of the nozzles can be supplied with paste by a paste cartridge which forms the upper part of the nozzle or of each nozzle, which contains a stock of paste advantageously sufficient to form at least one layer, and which can be refilled from a supply tank mounted or not to the machine or which can be replaced when it is empty with a full cartridge, it being possible that this replacement be performed by a robotic arm.

The or at least one of the nozzles can be moveably mounted by means of a robotic arm or to a holder which allows a movement in front of the scraping.

The or each nozzle can be mounted to a portal frame adapted to move on the frame over the working tray according to the length thereof, said portal frame being the portal frame equipped with the one or more scraping blades or being another portal frame, moveable independently thereof, the or each nozzle being further moveably mounted to a transversal rail of the portal frame which carries it.

In a particular embodiment, the portal frame is a portal frame equipped with scraping blades, especially comprising two scraping blades, one being operational when the portal frame moves in one direction, and the other, when the portal frame moves in the other direction, the or each nozzle being moveably mounted to a transversal rail of said portal frame, the or each nozzle being arranged between both blades.

In a particular embodiment, the machine according to the present invention can comprise at least two nozzles arranged according to the advance axis of the portal frame or according to a transversal axis.

The amplitude of one or of each nozzle in the portal frame can be greater than the width of the working tray, so that each nozzle is adapted to dispense paste at each point of the working tray.

The machine according to the present invention can comprise adjusting means of at least one parameter selected among the flow rate of the nozzle or of each nozzle and the transversal and longitudinal advance speeds of the or each nozzle, depending on at least one parameter selected especially among the viscosity of the paste and the thickness of the layer.

The machine according to the present invention can comprise controlling means of the paste deposit in a continuous way, thus forming a paste strand on the working surface, and/or in a discontinuous way, thus forming deposits by points on the working surface.

### BRIEF DESCRIPTION OF THE DRAWINGS

To better illustrate the subject-matter of the present invention, several particular embodiments of the scraping device of the machine according to the invention will be described hereinafter, by way of example and not limitation, with reference to the accompanying drawing. On each of the Figures, the arrow indicates the advance direction of the scraping device.

In this drawing:

FIGS. 1a and 1b are perspective schematic views respectively showing the back and the front of the scraping device according to a first embodiment of the invention;

FIGS. 2a and 2b are perspective schematic views respectively showing the back and the front of the scraping device according to a second embodiment of the invention; FIG. 2c is a view similar to FIG. 2b showing the device in a position to refill the paste cartridge;

FIGS. 3a to 3e show perspective schematic views of a scraping device according to a third embodiment of the invention in different positions/orientations according to which two scraping blades carried by a same double portal frame are provided, one being operational according to a first advance direction of the portal frame and the other being operational according to the opposite return direction of said double portal frame; FIGS. 3f and 3g show this scraping device in which the double portal frame is only partially represented, merely showing one of the blades;

FIGS. 4a and 4b show two perspective schematic views of two different positions of a scraping device according to a fourth embodiment of the invention, according to which the scraping blade is carried by a portal frame, and a paste dispensing nozzle is carried by another portal frame, independent of the previous one;

FIGS. 5a to 5c show three perspective schematic views showing, viewed from the back, three different positions of a scraping device according to a fifth embodiment of the present invention, according to which three paste dispensing nozzles are provided, mounted in an alignment parallel to two scraping blades;

FIGS. 6a and 6b are two perspective views of two different positions of a scraping device according to a sixth embodiment of the present invention, according to which three paste dispensing nozzles are also provided, mounted in an alignment parallel to one scraping blade; and

FIG. 7 is a perspective view of a scraping device according to a seventh embodiment of the present invention, according to which three paste dispensing nozzles are mounted in an alignment perpendicular to the scraping blade.

### DETAILED DESCRIPTION OF THE INVENTION

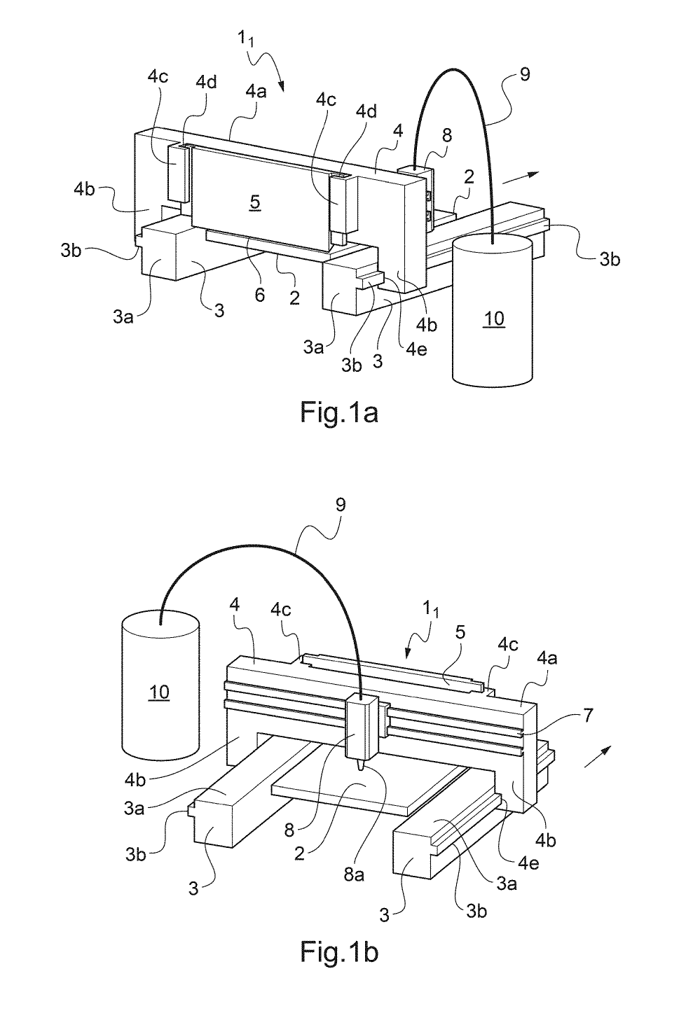

### First Embodiment: FIGS. 1a and 1b

In reference to FIGS. 1a and 1b, is shown a scraping device 1 of a paste layer on a working surface of a horizontal working tray 2 of a manufacturing machine of green bodies made of ceramic material by the technique of additive manufacturing. FIG. 1a shows the back of the scraping device, and FIG. 1b, the front thereof.

The scraping device 1 comprises, slidably mounted on the frame 3 of the machine, a portal frame 4 with a motor which drives it with a ball screw or a rack. A blade holder 5, in which is arranged a scraping blade 6, is integrally formed with the portal frame 4.

The frame 3 comprises two elongated blocks 3a located on either side of the working tray 2, each of these blocks 3a bearing a rib 3b which extends horizontally over its entire outer lateral face and the function of which is indicated below.

The portal frame 4 consists in a block comprising an upper part 4a in the form of an elongated rectangular parallelepiped which is arranged over the working tray 2 and the frame 3, transversally to the blocks 3a, and which extends by two lower lateral parts 4b.

The rear face of the upper part 4a comprises two vertical protrusions 4c, each having a U-shaped section a wing of which is contiguous to said rear face. The grooves 4d of these U-shaped sections are arranged opposite to each other. The function of these grooves 4d is indicated below.

In the vicinity of its base, each lateral part 4b comprises, inwardly facing, a groove 4e into which the block 3a associated to the frame 3 is adapted to slide by its corresponding rib 3b.

The blade holder 5 consists in a plate adapted to vertically slide by its two lateral edges into the grooves 4d of the associated vertical protrusions 4c of the portal frame 4. The scraping blade 6 is carried by the lower part of the blade holder 5. This scraping blade 6 can be seen on FIG. 1.

According to the invention, and as it can be seen on FIG. 1b, the front face of the upper part 4a of the portal frame 4 comprises a horizontal rail 7 which extends from a vertical edge to the other of the part 4a and in which is slidably mounted a nozzle 8 the outlet port 8a of which is vertically oriented to be located over the working tray 2 at each moment in front of the scraping blade 6. The nozzle 8 is continuously supplied by a flexible pipe 9 connected to a supply tank 10, for example a piston-type supply tank.

The functioning of the scraping device 1₁ of FIGS. 1a and 1b is as follows:

In reference to FIG. 1a, it can be seen that the scraping blade 6 is in scraping position, the blade holder 5 having been slidably lowered into the rails 4d of the portal frame 4 and stopped in such a position that the associated blade 6 can, when scraping, come to form the desired layer height.

In the position of FIG. 1a, the nozzle 8 is in rest position. For spreading the paste layer, from the position in FIG. 1a:
the nozzle 8 is connected to the tank 10 by the flexible pipe 9;
the nozzle 8 is moved in translation into the rail 7 so that its outlet port 8a comes over an edge of the working tray 2;
the paste starts to be spread by moving the portal frame 4 forward according to the arrow (FIG. 1a); during this moving of the portal frame 4, the supply of the nozzle 8 by the flexible pipe 9 is controlled at the same time as the movement in translation of the nozzle 8 from the aforementioned transversal edge to the other, and then in return and so on according to a back-and-forth movement. While the portal frame 4 moves simultaneously forward, a paste strand is deposited in zigzag way on the working tray 2, and immediately scraped by the scraping blade 6 until the layer is completely formed.

When the portal frame 4 reaches the end of its stroke, in other words when the paste layer is completely deposited, the supply of the nozzle 8 is stopped, the scraping blade 6 is raised by raising the blade holder 5 and the portal frame 4 is returned to its starting position (FIG. 1b). On FIG. 1b, the nozzle 8 was shown in an intermediate position along the rail 7; in this case, it will be returned to its starting position to deposit a new layer (position of FIG. 1a).

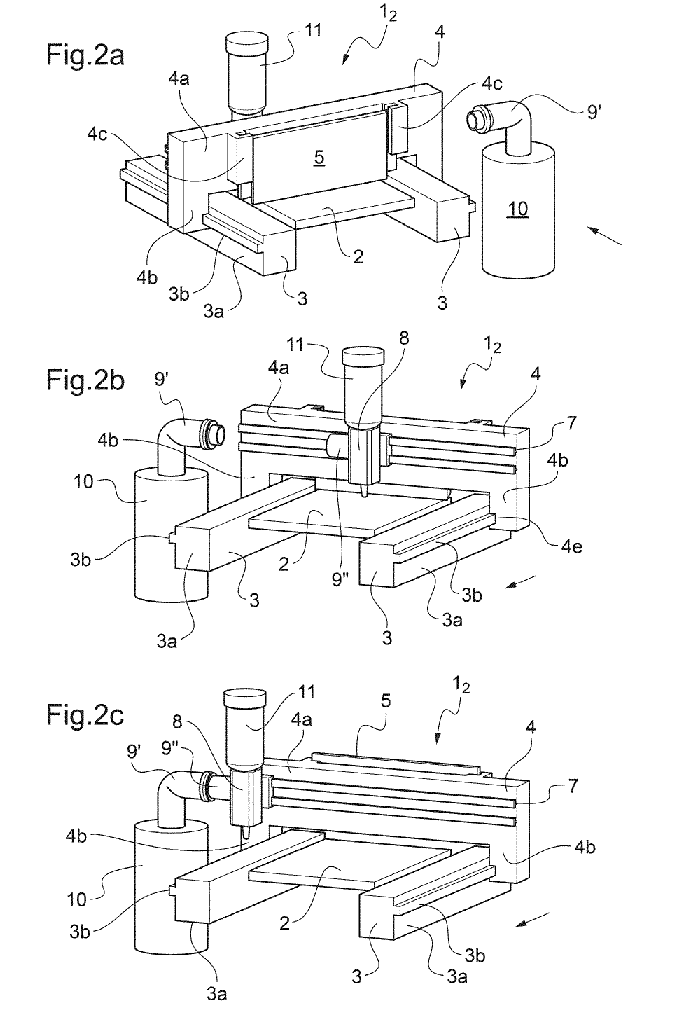

### Second Embodiment (FIGS. 2a to 2c)

In reference to FIGS. 2a to 2c, it can be seen a scraping device 1₂ which differs from the scraping device 1₁ in that the nozzle 8 is topped by a stock of paste or refill 11. This refill 11 is rechargeable from a tank 10 having an outlet pipe 9′, with an elbow shape in the example shown, which is adapted to connect through a short pipe 9″ protruding out from the nozzle 8.

The functioning of the scraping device 1₂ in FIGS. 2a to 2c is the same as that of the device 1₁ in

FIGS. 1a and 1b, except that the nozzle 8 is filled when making the connection between the outlet pipe 9′ and the short pipe 9″ (FIG. 2c); after filling, the short pipe 9″ and the outlet pipe 9′ are detached from each other.

On FIG. 2c, it is shown the scraping device 1₂ before the formation of a paste layer, in rest position, the blade holder 5 being in a raised position. The nozzle is in a paste filling position, the amount of paste having to be sufficient to form the layer.

Starting from the position shown on FIG. 2c, to spread a paste layer on the working tray 2, the blade holder 5 is lowered to put the associated blade in scraping position and the outlet pipe 9′ is detached from the short pipe 9″ once the nozzle 8 is filled with paste.

The simultaneous advance movements of the portal frame 4 and back-and-forth movements of the nozzle 8 into the rail 7 (see FIG. 2b in which the portal frame 4 is viewed from the front, and FIG. 2a in which the portal frame is viewed from the rear) are thus controlled.

Once the layer of paste is deposited, the blade holder 5 is raised and the portal frame 4 is returned to the position in FIG. 2c, and the refill of the nozzle 8 is performed in preparation for the paste deposit for the following layer.

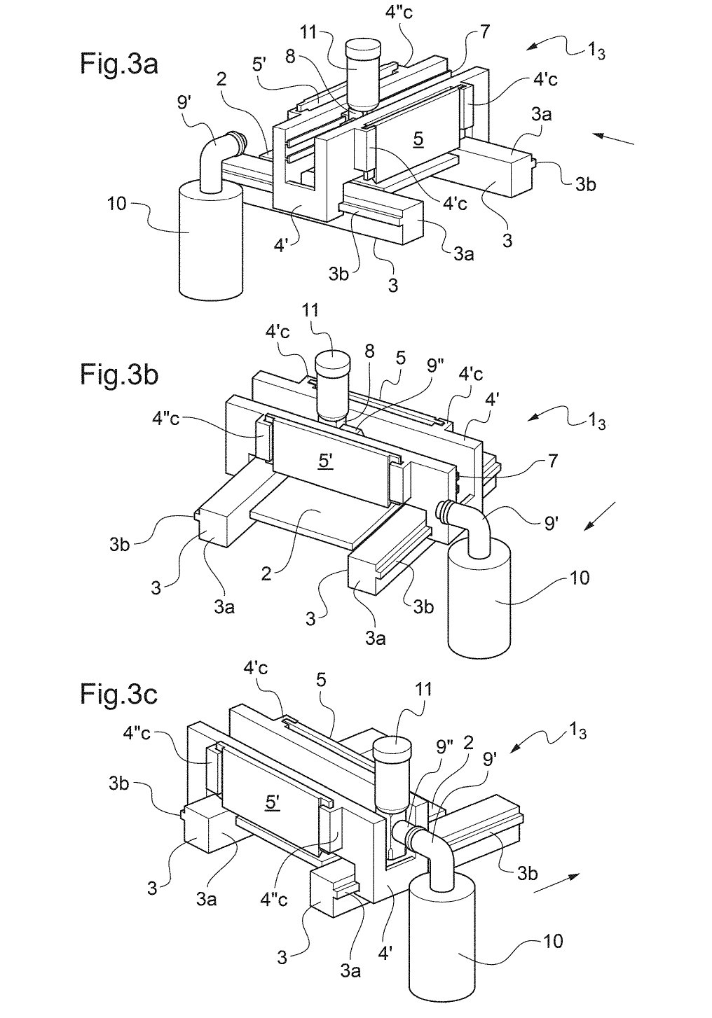

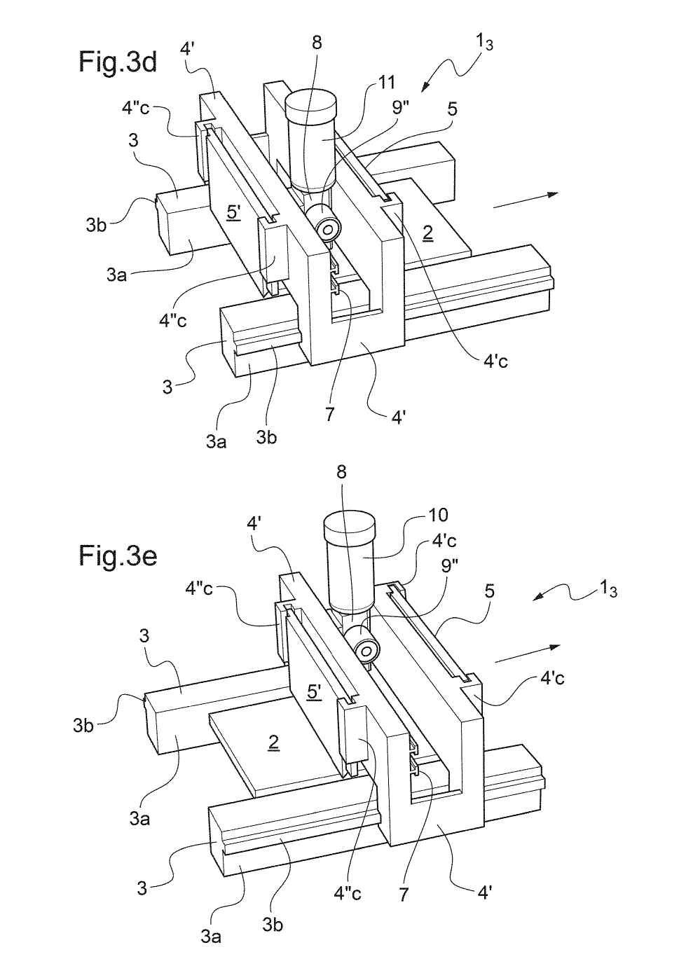

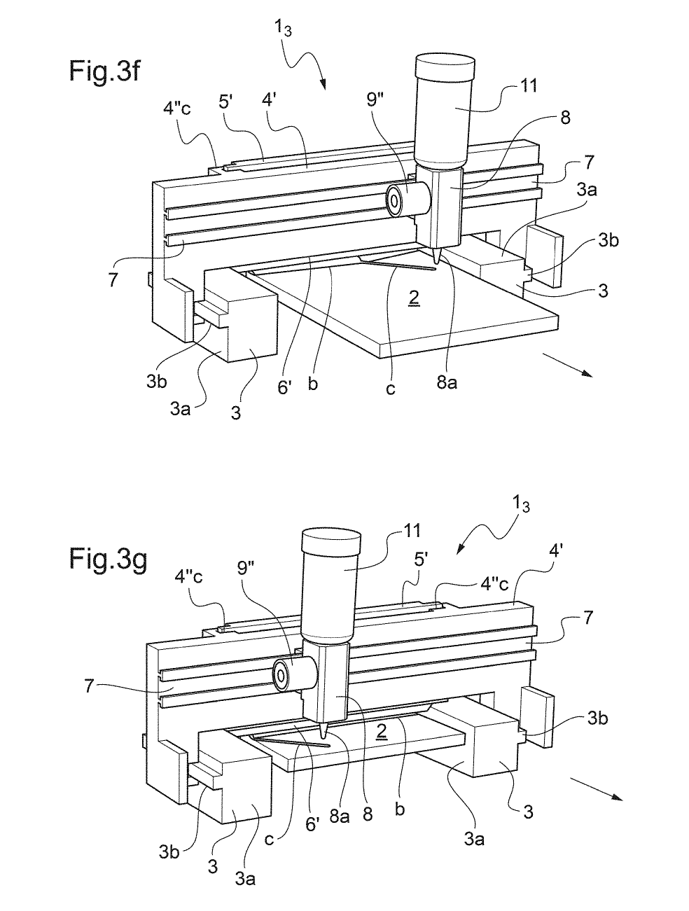

### Third Embodiment: FIGS. 3a to 3g

In reference to FIGS. 3a to 3g, it can be seen a scraping device 1₃ which differs from the scraping device 1₂ in that the portal frame 4 is replaced with the double portal frame 4′. The latter thus consists of two portal frames of similar type as the portal frame 4, parallel, gathered by their lower lateral parts to move as a unit block.

The faces of the upper parts of both portal frames making up the double portal frame 4′ comprise each two protrusions with a U-shaped section facing each other (respectively two protrusions 4′c and two protrusions 4″c), in which are slidably mounted, in the same way as in the previous embodiments, the blade holders 5 and 5′ respectively with their associated scraping blades (see blade 6′ on FIGS. 3f and 3g).

In the example shown, only the portal frame of the double portal frame 4′ comprising the blade holder 5′, has, on its inner face—the one which is turned towards the other portal frame, the rail 7 on which is transversally slidably mounted the nozzle 8 topped by its refill 11. Thus, the nozzle 8 is adapted to move between both portal frames of the double portal frame 4′.

Thus, the double portal frame 4′ will move from an end of the working tray 2 to the other on an forward stroke where only one scraping blade associated to a blade holder will be active, the opposite blade holder being raised so that its associated blade, raised, should not be operational, the double portal frame 4′ then moving on a return stroke for which the blades will be successively raised and lowered.

On FIGS. 3f and 3g—as well as in next figures—«b» refers to the thin bead and «c» refers to the paste strand.

The functioning of the scraping device 1₃ can be described with reference to FIGS. 3a to 3e:

### FIG. 3a (Rear View) and FIG. 3b (Front View)—Formation of a Layer

The blade associated to the blade holder 5 is lowered and the one associated to the blade holder 5′ is raised. The blade associated to the blade holder 5 is therefore operational, the portal frame 4 moving according to the arrow indicated with paste being deposited by the nozzle 8 which transversally moves back and forth along the rail 7.

### FIG. 3c

After forming the layer, the refilling takes place as in the previous embodiment. The blade associated to the blade holder 5′ is lowered and the one associated to the blade holder 5 is raised. The blade associated to the blade holder 5′ will therefore be operational to form the following layer, the portal frame 4′ being ready to move in the opposite direction.

### FIGS. 3d and 3e: Formation of the Following Layer

The portal frame 4′ moves according to the arrow indicated (FIG. 3d: initial position and FIG. 3e: final position) with paste being deposited by the nozzle 8 which transversally moves back and forth along the rail 7.

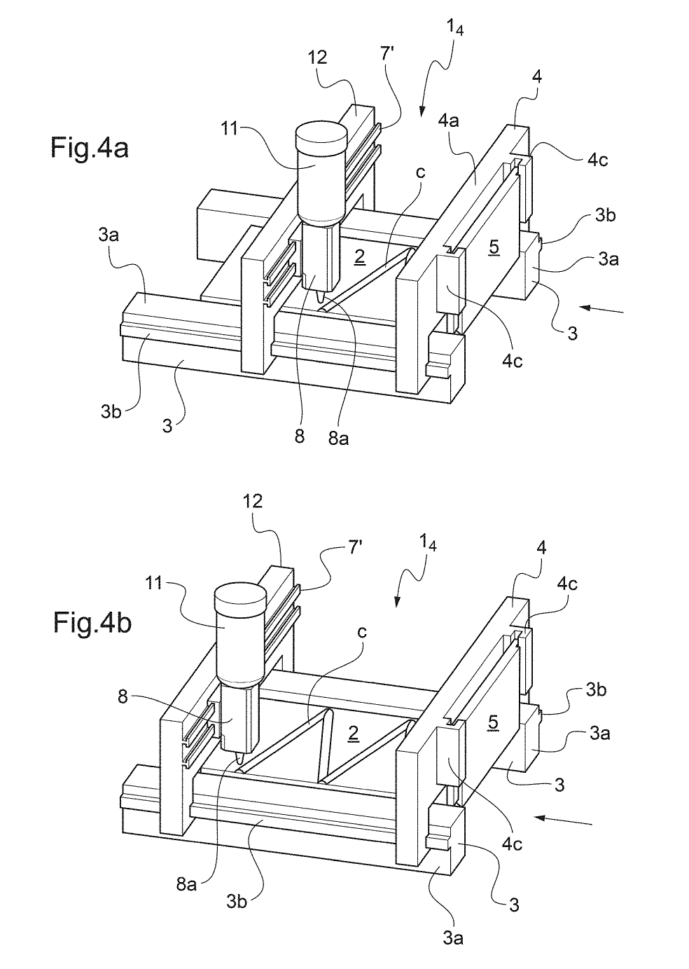

### Fourth Embodiment: FIGS. 4a and 4b

In reference to FIGS. 4a and 4b, it can be seen a scraping device 1₄ which differs from the scraping device 1₂ in that it comprises, at a distance from the portal frame 4, a portal frame 12, which is moveable independently of the portal frame 4. The portal frame 4 comprises the blade holder 5 and its associated scraping blade, but does not have the rail 7. The portal frame 12 which has the rail, indicated by 7′, on which the nozzle 8, with its refill 11, is transversally slidably mounted.

The functioning is the same as for the devices 1₁ and 1₂.

It can be seen, when comparing FIGS. 4a and 4b, that the deposit of the paste strand c by the nozzle 8, may be controlled independently of the scraping blade.

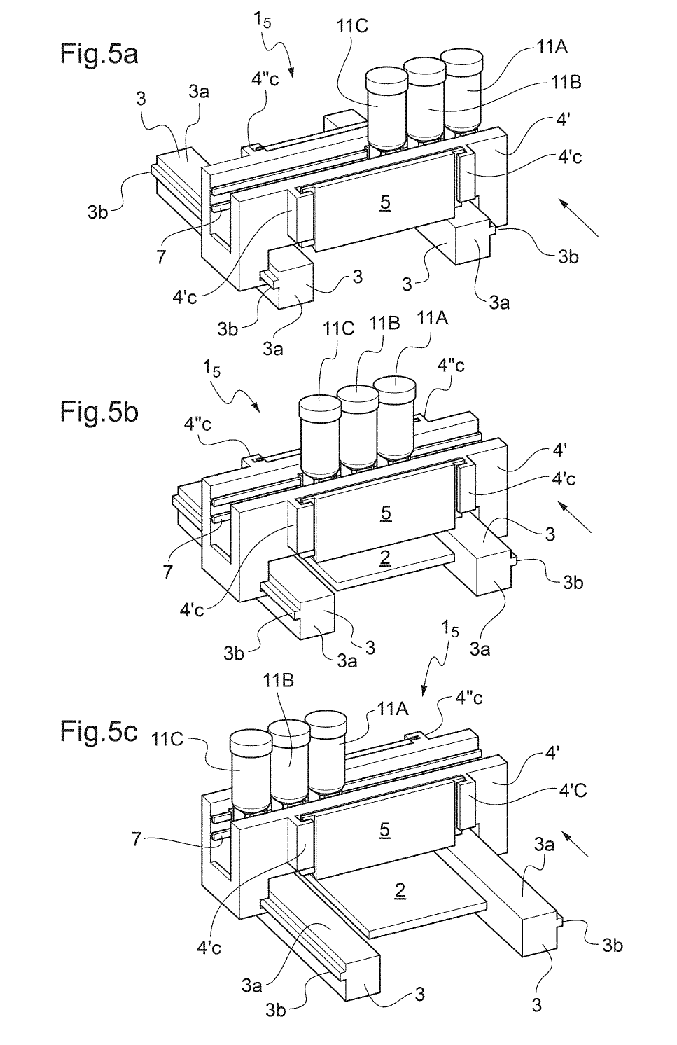

### Fifth Embodiment: FIGS. 5a to 5c

In reference to FIGS. 5a to 5c, it can be seen a scraping device 1₅ which differs from the scraping device in that, in the rail 7, are slidably mounted three nozzles—the refills 11A, 11B, 11C of which can be seen—arranged side by side.

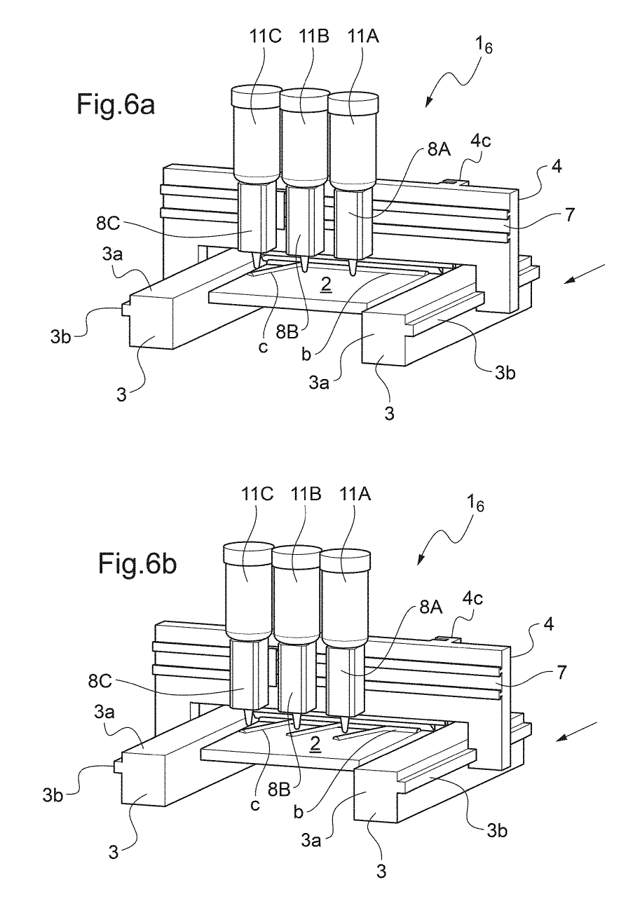

### Sixth Embodiment: FIGS. 6a and 6b

In reference to FIGS. 6a and 6b, it can be seen a scraping device 1₆ which differs from the scraping device 1₂ in that, in the rail 7, are mounted side by side three nozzles 8A, 8B, 8C topped by their refills 11A, 11B, 11C respectively which are manually exchangeable.

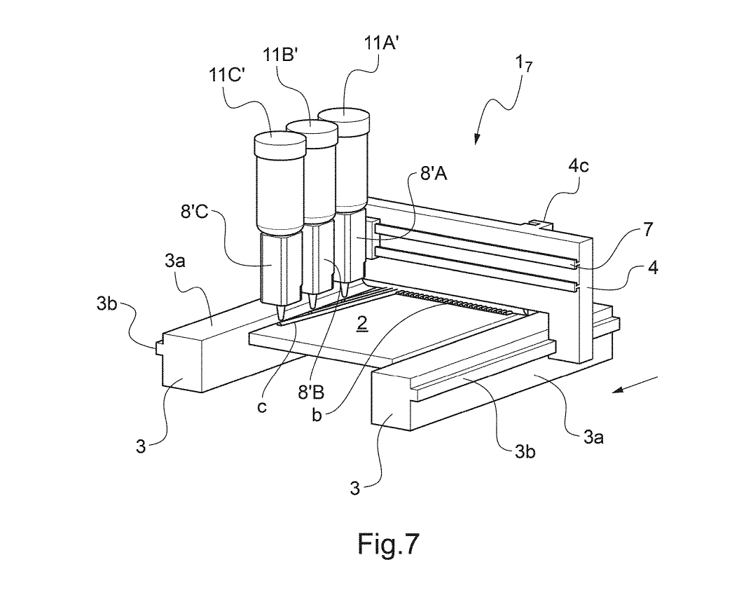

### Seventh Embodiment: FIG. 7

In reference to FIG. 7, it can be seen a scraping device 1₇ which differs from the scraping device 1₆ in that the nozzles 11A′, 11B′ and 11C′ are contiguous according to a transversal direction to the rail 7.

The devices 1₅, 1₆ and 1₇ can be useful if a large amount of paste to be deposited is desired or if the type of paste is desired to be changed between layers, in which case, only one nozzle is operated to apply one layer.

1-19. (canceled)

20. A method for manufacturing a piece made of ceramic material, by the technique of additive manufacturing according to which layers of a photocurable paste are successively allowed to cure according to a pattern defined for each layer, the first layer being formed on a working surface on a working tray, each layer, before curing according to a defined pattern, being spread by scraping by at least one scraping blade from an amount of paste supplied onto the working tray, the working tray being lowered upon each formation of a layer, wherein, upon each formation of a layer, the amount of paste necessary to form the layer is dispensed onto the working surface, from at least one nozzle which is moved in front of the forefront at least one scraping blade.

21. The method according to claim 20, wherein the at least one nozzle is moved transversally back and forth parallel to the at least one scraping blade and longitudinally according to the advance movement of the at least one scraping blades from an edge of the working surface to the opposite edge of the working surface.

22. The method according to claim 21, wherein at least one parameter selected among the flow rate of the at least one nozzle and the transversal and longitudinal advance speeds of the at least one nozzle is adjusted depending on at least one parameter selected among the viscosity of the paste and the thickness of the layer.

23. The method according to claim 20, wherein the dispensing of paste by the at least one nozzle is controlled depending on the layer to be formed.

24. The method according to claim 20, wherein the at least one nozzle is supplied with paste by means of a pipe for supplying paste from a paste tank.

25. The method according to claim 20, wherein the at least one nozzle is supplied with paste by means of a paste cartridge which forms the upper part of the at least one nozzle and which contains a stock of paste sufficient to form at least one layer.

26. The method according to claim 20, wherein the paste is dispensed from at least two nozzles aligned according to an axis, the axis being one of an axis parallel to the at least one scraping blade and an axis perpendicular to the at least one scraping blade.

27. The method according to claim 20, wherein, when spreading at least one of the paste layers, at least one scraping blade in working position, in addition to its scraping advance movement, is allowed to go back and forth in its plane according to a so-called vibration motion.

28. The method according to claim 20, wherein the paste deposit is controlled in at least one of a continuous way, forming a paste strand on the working surface, and a discontinuous way, forming deposits by points on the working surface.

29. A machine for manufacturing pieces made of ceramic material, by the technique of additive manufacturing according to which layers of photocurable paste are successively allowed to cure by irradiation according to a pattern defined for each layer, the machine comprising:
a frame surrounding a horizontal working tray comprising a working surface;
a portal frame equipped with at least one scraping blade, the portal frame being adapted to move on the frame over the working tray so that the free edge of the at least one scraping blade is adapted to spread, by scraping, paste layers over the working surface, the layers being vertically superimposed;
irradiation means facing the working tray to irradiate each layer once spread to cure the layer in the previously defined pattern before spreading the following layer, the following layer being in turn cured in the defined pattern; and
supplying means of an amount of paste on the working tray upon each formation of a layer, the amount being intended to be spread by scraping by the at least one scraping blade so as to form the associated layer,
wherein the supplying means of an amount of paste on the working tray are constituted by at least one dispensing nozzle moveable in front of the forefront of at least one scraping blade, the at least one dispensing nozzle being adapted to apply paste according to a predefined program corresponding to the associated layer, so that the at least one scraping blade can spread the paste applied in a uniform layer when passing over the layer.

30. The machine according to claim 29, wherein the at least one nozzle is supplied with paste by a flexible pipe connected to a paste tank.

31. The machine according to claim 29, wherein the at least nozzle is supplied with paste by a paste cartridge which forms the upper part of the at least one nozzle, which contains a stock of paste sufficient to form at least one layer.

32. The machine according to claim 29, wherein the at least one nozzle is mounted on one of a robotic arm and a holder which allows a movement in front of the scraping.

33. The machine according to claim 29, wherein the at least one nozzle is mounted to a portal frame adapted to move on the frame over the working tray according to the length of the frame, the portal frame being one of the portal frame equipped with the at least one scraping blade and another portal frame, moveable independently of the frame, the at least one nozzle being further moveably mounted to a transversal rail of the portal frame which carries it.

34. The machine according to claim 33, wherein the portal frame is a portal frame equipped with at least two scraping blade, one being operational when the portal frame moves in one direction, and the other, when the portal frame moves in the other direction, the at least one nozzle being moveably mounted to a transversal rail of the portal frame, the at least one nozzle being arranged between the at least two blades.

35. The machine according to claim 29, wherein the machine comprises at least two nozzles arranged according one axis, the axis being one of the advance axis of the portal frame and an axis transversal to the advance axis of the portal frame.

36. The machine according to claim 29, wherein the amplitude of the at least one nozzle in the portal frame is greater than the width of the working tray, so that each nozzle is adapted to dispense paste at each point of the working tray.

37. The machine according to claim 29, wherein the machine comprises adjusting means of at least one parameter selected among the flow rate of the at least one nozzle and the transversal and longitudinal advance speeds of the at least one nozzle, depending on at least one parameter selected among the viscosity of the paste and the thickness of the layer.

38. The machine according to claim 29, wherein the machine comprises controlling means of the paste deposit in at least one of a continuous way, forming a paste strand on the working surface, and a discontinuous way, forming deposits by points on the working surface.
